(19) United States
(12) Patent Application Publication
(10) Pub. No.: US 2013/0322117 A1
(43) Pub. Date: Dec. 5, 2013

(54) Backlight Module

(71) Applicants: Yicheng Kuo, Shenzhen (CN); Gege Zhou, Shenzhen (CN)

(72) Inventors: Yicheng Kuo, Shenzhen (CN); Gege Zhou, Shenzhen (CN)

(73) Assignee: Shenzhen China Star Optoelectronics Technology Co. LTD., Shenzhen City, Guangdong (CN)

(21) Appl. No.: 13/575,296

(22) PCT Filed: Jun. 5, 2012
(86) PCT No.: PCT/CN12/76455

§ 371 Date: Jul. 25, 2012

(30) Foreign Application Priority Data
May 30, 2012 (CN) 201210174111.5

(51) Int. Cl. G09F 13/04

(52) U.S. Cl. 362/611

(57) ABSTRACT

The present invention provides a backlight module, which includes a backplane, a light guide plate arranged inside the backplane, and a first backlight source arranged inside the backplane. The backplane includes a main body and a first bracket connected to the main body. The main body includes a base plate, which includes a first lap section adjacent to an edge of the first bracket. The first bracket includes a first connection section adjacent to an edge of the base plate and corresponding to the first lap section. The first lap section and the first connection section are lapped on each other. A plurality of first and second bolts joints the first lap section and the first connection section together. The plurality of first and second bolts is arranged in two rows. The backplane is composed of the main body and the bracket that are jointed by two rows of bolts.

### BACKGROUND OF THE INVENTION

1. Field of the Invention

The present invention relates to the field of liquid crystal displaying, and in particular to a backlight module.

2. The Related Arts

Liquid crystal display (LCD) has a variety of advantages, such as thin device body, low power consumption, and being free of radiation, and is thus widely used. Most of the LCDs that are currently available in the market are backlighting LCDs, which comprise a liquid crystal display panel and a backlight module. The working principle of the liquid crystal display panel is that liquid crystal molecules are interposed between two parallel glass substrates and a plurality of vertical and horizontal fine electrical wires is arranged between the two glass substrates, whereby the liquid crystal molecules are controlled to change direction by application of electricity in order to refract light emitting from the backlight module for generating images. Since the liquid crystal display panel itself does not emit light, light must be provided by the backlight module in order to normally display images. Thus, the backlight module is one of the key components of an LCD. The backlight module can be classified as two types, namely side-edge backlight module and direct backlight module, according to the position where light gets incident. The direct backlight module arranges a light source, such as a cold cathode fluorescent lamp (CCFL) or a light-emitting diode (LED) at the back side of the liquid crystal display panel to form a planar light source that directly provides lighting to the liquid crystal display panel. The side-edge backlight module arranges a backlight source, such as an LED light bar based backlight source, at an edge of a back panel to be located rearward of one side of the liquid crystal display panel. The LED backlight source emits light that enters a light guide plate through a light incident face of the light guide plate and is projected out through a light exit face after being reflected and diffused to thereby form a planar light source for the liquid crystal display panel.

A conventional backlight module generally comprises a backplane, a light guide plate, a backlight source, and optic films. The backplane is generally made of a single material, and the material used is aluminum sheet, steel sheet, or plastics. Since aluminum sheet has a higher cost than steel sheet, the portion of an aluminum backplane that is not effective in dissipating heat can be replaced by a steel plate and the two portions of the backplane that are of different material can then be jointed to form a jointed composite-material backplane, which is helpful for lowering down cost.

Referring to FIG. 1, which shows a conventional backlight module 200 that comprises a jointed backplane, the jointed backplane 200 comprises a main body 202 and a first bracket 204 connected to an end of the main body 202. The main body 202 and the first bracket 204 are jointed together by bolts 203, in which the bolts 203 are arranged in a row. This leads to a potential situation that the main body 202 and the first bracket 204 may get rotatable relative to each other, and consequently, the flatness of the backplane 200 deteriorates, making the optic grade lowered and being adverse to cost control.

As shown in FIG. 2, which is a backlight module that comprises a jointed dual side incidence backplane, the jointed backplane 200′ comprises a main body 202′ that comprises a base plate 205 and a second bracket 206 connected to the base plate 205. The second bracket 206 is secured to the base plate 205 by a row of bolts 207. Again, the same drawback as that discussed above exists.

Further, in a backlight module, fixing a light guide plate requires designing a special fixing structure to effect fixing. This, to some extents, increases the manufacture cost.

### SUMMARY OF THE INVENTION

Thus, an object of the present invention is to provide a backlight module, which has a simple structure, excellent performance of heat dissipation, high strength, and low cost and is helpful for enhancing optic grade.

Another object of the present invention is to provide a backlight module, which has a simple structure, excellent performance of heat dissipation, high strength, and low cost, is helpful for enhancing optic grade, and is easy to fix a light guide plate.

To achieve the objects, the present invention provides a backlight module, which comprises a backplane, a light guide plate arranged inside the backplane, and a first backlight source arranged inside the backplane. The backplane comprises a main body and a first bracket connected to the main body. The main body comprises a base plate, which comprises a first lap section adjacent to an edge of the first bracket. The first bracket comprises a first connection section adjacent to an edge of the base plate and corresponding to the first lap section. The first lap section and the first connection section are lapped on each other. A plurality of first and second bolts joints the first lap section and the first connection section together. The plurality of first and second bolts is arranged in two rows.

The light guide plate forms first holes corresponding to the second bolts. The second bolts extend into the first holes of the light guide plate.

The main body comprises a side plate integrally connected with the base plate. The main body is made of a high strength material. The first bracket is made of a high thermal conductivity material. The first backlight source is mounted to the first bracket. The main body is made of a steel plate. The first bracket is made of an aluminum plate.

The first connection section forms two rows of threaded holes. The first lap section forms two rows of through holes. The first and second bolts respectively extend through the through holes to screw into the threaded holes. The second bolts further extend through the threaded holes to engage the first holes.

The backlight module further comprises a reflector plate arranged inside the backplane and located below the light guide plate and an optic film assembly arranged on the light guide plate. The reflector plate forms first through holes corresponding to the first holes.

The main body comprises a second bracket connected to another edge of the base plate opposite to the first bracket. A second backlight source is mounted to the second bracket. The second bracket is made of a high thermal conductivity material. The base plate is made of a high strength material. The base plate comprises a second lap section adjacent to an edge of the second bracket. The second bracket comprises a second connection section adjacent to said another edge of the base plate and corresponding to the second lap section. The second lap section and the second connection section are lapped on each other. A plurality of third and fourth bolts joints the second lap section and the second connection section together. The plurality of third and fourth bolts is arranged in two rows.

The light guide plate forms second holes corresponding to the fourth bolts. The fourth bolts extend into the second holes of the light guide plate.

The second bracket is made of aluminum plate and the base plate is made of steel plate.

The second connection section forms two rows of threaded holes. The second lap section forms two rows of through holes. The third and fourth bolts respectively extend through the through holes to screw into the threaded holes. The fourth bolts further extend through the threaded holes to engage the second holes. The first bolts and the third bolts are identical to each other. The second bolts and the fourth bolts are identical to each other.

The backlight module further comprises a reflector plate arranged inside the backplane and located below the light guide plate and an optic film assembly arranged on the light guide plate. The reflector plate forms first and second through holes respectively corresponding to the first and second holes.

The efficacy of the present invention is that the present invention provides a backlight module, which comprises a backplane that is formed by jointing a main body and a bracket. By arranging two rows of bolts to fix the main body and the bracket, relative rotation between the main body and the bracket can be effectively prevented. Meanwhile, connecting the main body and the bracket also effects fixing the light guide plate so as to eliminate a separate arrangement of fixing structure for the light guide plate thereby lowering down the manufacture cost. Further, the main body of the backplane is made of a high strength material and the bracket is made of a high thermal conductivity material. This ensures the strength of the backplane and also exhibits excellent thermal conduction to thereby enhance the grade of the backlight module.

For better understanding of the features and technical contents of the present invention, reference will be made to the following detailed description of the present invention and the attached drawings. However, the drawings are provided for the purposes of reference and illustration and are not intended to impose undue limitations to the present invention.

### BRIEF DESCRIPTION OF THE DRAWINGS

The technical solution, as well as beneficial advantages, will be apparent from the following detailed description of an embodiment of the present invention, with reference to the attached drawings. In the drawings:

FIG. 1 is a schematic view showing a conventional backlight module;

FIG. 2 is a schematic view showing a conventional dual side incidence backlight module;

FIG. 3 is a schematic view showing a backlight module according to the present invention;

FIG. 4 is an exploded view showing a backplane of FIG. 3;

FIG. 5 is a schematic view showing a backlight module according to another embodiment of the present invention; and

FIG. 6 is an exploded view showing a backplane of FIG. 5.

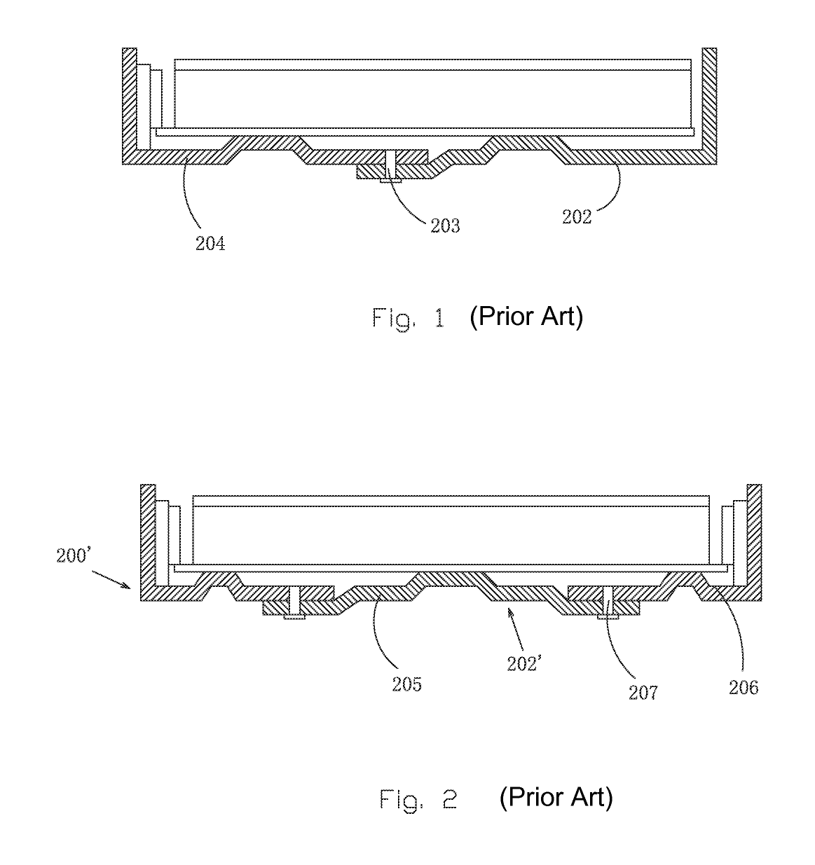

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

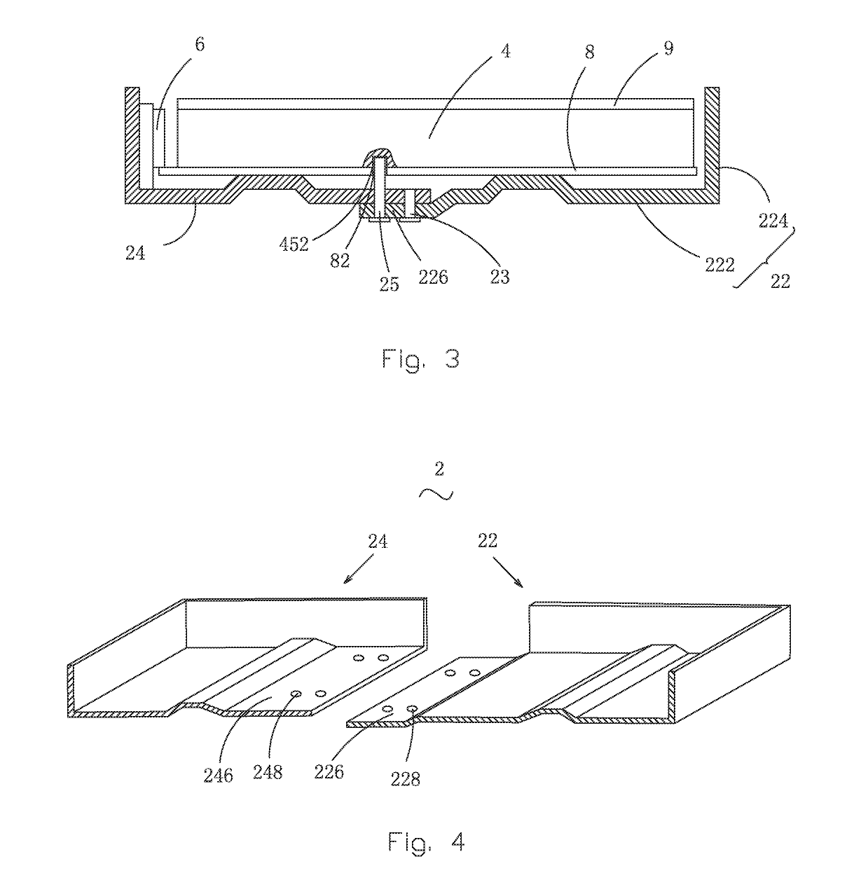

Referring to FIGS. 3 and 4, the present invention provides a backlight module, which comprises: a backplane 2, a light guide plate 4 arranged inside the backplane 2, and a first backlight source 6 arranged inside the backplane 2.

The backplane 2 comprises a main body 22 and a first bracket 24 connected to the main body 22. The main body 22scomprises a base plate 222 and a side plate 224 integrally connected with the base plate 222. The base plate 222 comprises a first lap section 226 adjacent to an edge of the first bracket 24. The first bracket 24 comprises a first connection section 246 adjacent to the base plate 22 and corresponding to the first lap section 226. To assemble, the first lap section 226 is lapped on the first connection section 246 and is jointed thereto by a plurality of first and second bolts 23, 25. The first and second bolts 23, 25 are arranged in two rows so as to effectively prevent relative rotation between the main body 22 and the first bracket 24 thereby enhancing the optic grade of the backlight module.

The light guide plate 4 forms first holes 452 corresponding to the second bolts 25. The second bolts 25 extend through the first connection section 246 and the first lap section 226 to get into the first holes 452 of the light guide plate 4.

The first connection section 246 forms two rows of threaded holes 248, and the first lap section 226 form two rows of through holes 228. The first and second bolts 23, 25 are respectively put through the through holes 228 to screw into the threaded holes 248. Further, after extending through the threaded holes 248, the second bolts 25 engage the first holes 452 to assist in fixing the light guide plate 4 in position.

The main body 22 is made of a high strength material, preferably a steel plate, in order to ensure proper strength of the backplane 2. The first bracket 24 is made of a high thermal conductivity material, preferably an aluminum plate. The first backlight source 6 is mounted to the first bracket 24 to enhance thermal conduction and improving the grade of the backlight module.

The backlight module according to the present invention further comprises a reflector plate 8 that is arranged inside the backplane 2 and located below the light guide plate 4 and an optic film assembly 9 arranged on the light guide plate 4. The reflector plate 8 forms first through holes 82 to correspond to the first holes 452 and the second bolts 25 extend through the first through holes 82 to assist in fixing the reflector plate 8 in position.

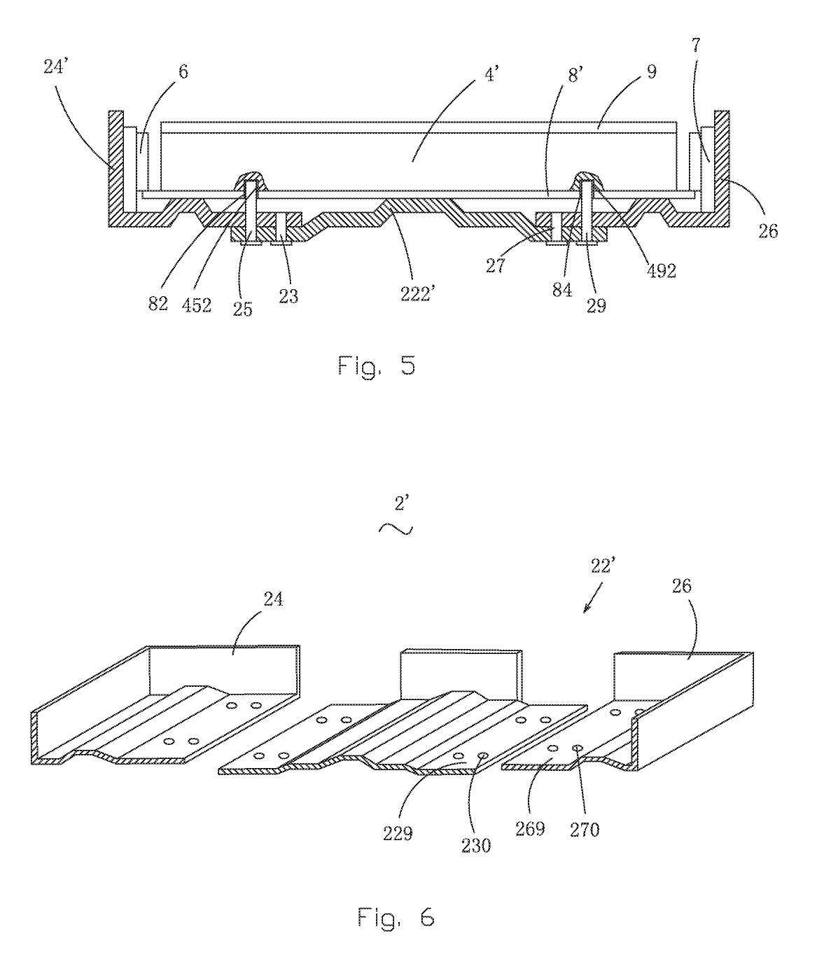

Referring to FIGS. 5 and 6, which are views illustrating a backlight module according to another embodiment of the present invention, a backplane 2′ comprises a main body 22′ and a first bracket 24 connected to the main body 22′. The connection structure between the first bracket 24 and the main body 22′ is identical to what discussed with reference to the previous embodiment. The main body 22′ comprises a base plate 222′ and a second bracket 26 connected to another edge of the base plate 222′ that is opposite to the first bracket 24. A second backlight source 7 is mounted to the second bracket 26. The second bracket 26 is made of a high thermal conductivity material, preferably an aluminum plate, to enhance thermal conduction. The base plate 222′ is made of a high strength material, preferably a steel plate, in order to enhance the strength thereof. The base plate 222′ comprises a second lap section 229 adjacent to an edge of the second bracket 26. The second bracket 26 comprises a second connection section 269 adjacent to said another edge of the base plate 222′ and corresponding to the second lap section 229. The second lap section 229 and the second connection section 269 are lapped on each other and a plurality of third and fourth bolts 27, 29 joints the second lap section 229 and the second connection section 269 together. The plurality of third and fourth bolts 27, 29 is arranged in two rows.

The light guide plate 4′ forms second holes 492 corresponding to the fourth bolts 29. The fourth bolts 29 extend into the second holes 492 of the light guide plate 4′ to assist in fixing the light guide plate 4′ in position.

The second connection section 269 forms two rows of threaded holes 270 and the second lap section 229 forms two rows of through holes 230. The third and fourth bolts 27, 29 respectively extend through the through holes 230 to screw into the threaded holes 270. The fourth bolts 29 are put through the threaded holes 270 to engage the second hole 492. The first bolts 23 can be identical to the third bolts 27 and the second bolts 25 can be identical to the fourth bolts 29.

In the instant embodiment, the backlight module further comprises a reflector plate 8′ that is arranged inside the backplane 2′ and located below the light guide plate 4′ and an optic film assembly 9 arranged on the light guide plate 4′. The reflector plate 8′ forms first and second through holes 82, 84 to respectively correspond to the first and second holes 452, 492 for receiving the second and fourth bolts 25, 29 therein.

In summary, the present invention provides a backlight module, which comprises a backplane that is formed by jointing a main body and a bracket. By arranging two rows of bolts to fix the main body and the bracket, relative rotation between the main body and the bracket can be effectively prevented. Meanwhile, connecting the main body and the bracket also effects fixing the light guide plate so as to eliminate a separate arrangement of fixing structure for the light guide plate thereby lowering down the manufacture cost. Further, the main body of the backplane is made of a high strength material and the bracket is made of a high thermal conductivity material. This ensures the strength of the backplane and also exhibits excellent thermal conduction to thereby enhance the grade of the backlight module.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A backlight module, comprising a backplane, a light guide plate arranged inside the backplane, and a first backlight source arranged inside the backplane, the backplane comprising a main body and a first bracket connected to the main body, the main body comprising a base plate, which comprises a first lap section adjacent to an edge of the first bracket, the first bracket comprising a first connection section adjacent to an edge of the base plate and corresponding to the first lap section, the first lap section and the first connection section being lapped on each other, a plurality of first and second bolts jointing the first lap section and the first connection section together, the plurality of first and second bolts being arranged in two rows.

2. The backlight module as claimed in claim 1, wherein the light guide plate forms first holes corresponding to the second bolts, the second bolts extending into the first holes of the light guide plate.

3. The backlight module as claimed in claim 1, wherein the main body comprises a side plate integrally connected with the base plate, the main body being made of a high strength material, the first bracket being made of a high thermal conductivity material, the first backlight source being mounted to the first bracket, the main body being made of a steel plate, the first bracket being made of an aluminum plate.

4. The backlight module as claimed in claim 2, wherein the first connection section forms two rows of threaded holes, the first lap section forming two rows of through holes, the first and second bolts respectively extending through the through holes to screw into the threaded holes, the second bolts further extending through the threaded holes to engage the first holes.

5. The backlight module as claimed in claim 2 further comprising a reflector plate arranged inside the backplane and located below the light guide plate and an optic film assembly arranged on the light guide plate, the reflector plate forming first through holes corresponding to the first holes.

6. The backlight module as claimed in claim 2, wherein the main body comprise a second bracket connected to another edge of the base plate opposite to the first bracket, a second backlight source mounted to the second bracket, the second bracket being made of a high thermal conductivity material, the base plate being made of a high strength material, the base plate comprising a second lap section adjacent to an edge of the second bracket, the second bracket comprising a second connection section adjacent to said another edge of the base plate and corresponding to the second lap section, the second lap section and the second connection section being lapped on each other, a plurality of third and fourth bolts jointing the second lap section and the second connection section together, the plurality of third and fourth bolts being arranged in two rows.

7. The backlight module as claimed in claim 6, wherein the light guide plate forms second holes corresponding to the fourth bolts, the fourth bolts extending into the second holes of the light guide plate.

8. The backlight module as claimed in claim 6, wherein the second bracket is made of aluminum plate and the base plate is made of steel plate.

9. The backlight module as claimed in claim 7, wherein the second connection section forms two rows of threaded holes, the second lap section forming two rows of through holes, the third and fourth bolts respectively extending through the through holes to screw into the threaded holes, the fourth bolts further extending through the threaded holes to engage the second holes, the first bolts and the third bolts being identical to each other, the second bolts and the fourth bolts being identical to each other.

10. The backlight module as claimed in claim 7 further comprising a reflector plate arranged inside the backplane and located below the light guide plate and an optic film assembly arranged on the light guide plate, the reflector plate forming first and second through holes respectively corresponding to the first and second holes.

11. A backlight module, comprising a backplane, a light guide plate arranged inside the backplane, and a first backlight source arranged inside the backplane, the backplane comprising a main body and a first bracket connected to the main body, the main body comprising a base plate, which comprises a first lap section adjacent to an edge of the first bracket, the first bracket comprising a first connection section adjacent to an edge of the base plate and corresponding to the first lap section, the first lap section and the first connection section being lapped on each other, a plurality of first and second bolts jointing the first lap section and the first connection section together, the plurality of first and second bolts being arranged in two rows;
wherein the light guide plate forms first holes corresponding to the second bolts, the second bolts extending into the first holes of the light guide plate;
wherein the main body comprises a side plate integrally connected with the base plate, the main body being made of a high strength material, the first bracket being made of a high thermal conductivity material, the first backlight source being mounted to the first bracket, the main body being made of a steel plate, the first bracket being made of an aluminum plate;
wherein the first connection section forms two rows of threaded holes, the first lap section forming two rows of through holes, the first and second bolts respectively extending through the through holes to screw into the threaded holes, the second bolts further extending through the threaded holes to engage the first holes; and
further comprising a reflector plate arranged inside the backplane and located below the light guide plate and an optic film assembly arranged on the light guide plate, the reflector plate forming first through holes corresponding to the first holes.
